(19) United States
(12) Patent Application Publication
(10) Pub. No.: US 2008/0301247 A1
(43) Pub. Date: Dec. 4, 2008

(54) AUTOMATIC FILE SHARING OVER A NETWORK

(75) Inventors: Chris Halim, Aliso Viejo, CA (US); Stephen Owens, Aliso Viejo, CA (US); Hong Quang Bui, Aliso Viejo, CA (US)

Correspondence Address: BLACK LOWE & GRAHAM, PLLC, 701 FIFTH AVENUE, SUITE 4800, SEATTLE, WA, 98104, US

(73) Assignee: MEMEO, INC., Aliso Viejo, CA (US)

(21) Appl. No.: 12/131,775

(22) Filed: Jun. 2, 2008

Related U.S. Application Data
(60) Provisional application No. 60/941,534, filed on Jun. 1, 2007.

(51) Int. Cl. G06F 15/16

(52) U.S. Cl. 709/206

(57) ABSTRACT

A system includes a server, a source client executable on a first electronic device configured to be in communication with the server. The source client is operable to automatically upload a file to the server in response to a user of the first electronic device placing the file in a first electronic folder. The source client is configured to associate a first network address with the first electronic folder in response to a user instruction. A recipient client is executable on a second electronic device configured to be in communication with the server. The second electronic device is located at the first network address. The recipient client is operable to receive from the server the uploaded file.

### CROSS-REFERENCE TO RELATED APPLICATIONS

This application claims priority to U. S. Provisional Appl. No. 60/941,534 entitled “AUTOMATIC FILE SHARING OVER A NETWORK” and filed Jun. 1, 2007, which is hereby incorporated by reference in its entirety.

### FIELD OF THE INVENTION

This invention relates generally to computer-implemented processes and, more specifically, to file sharing among electronic devices.

### BACKGROUND OF THE INVENTION

File sharing between computers within a local area network is usually built into the host operating system (e.g., Windows XP, Mac OS, etc.). Sharing of files/content between users on the Internet is currently done by the use of third-party applications (e.g., instant messaging applications, ftp server, email, online storage, etc.).

There are various products that allow users to transfer files from one PC to another, but those applications require both peer PCs to be connected to a network simultaneously. RSS feeds allow customers to “subscribe” to content published by an information provider and pulled down to the local PC.

However, file sharing via the existing methods is cumbersome and not so easy to use. Peer-to-peer sharing require both PCs to be connected to a network. RSS feeds is a one-to-many model where an information provider is publishing a common set of information to many people (as opposed to an individual publishing specific content for a small group).

Other problems with the prior art not described above can also be overcome using the teachings of embodiments of the present invention, as would be readily apparent to one of ordinary skill in the art after reading this disclosure.

### SUMMARY OF THE INVENTION

In an embodiment, a system includes a server, a source client executable on a first electronic device configured to be in communication with the server. The source client is operable to automatically upload a file to the server in response to a user of the first electronic device placing the file in a first electronic folder. The source client is configured to associate a first network address with the first electronic folder in response to a user instruction. A recipient client is executable on a second electronic device configured to be in communication with the server. The second electronic device is located at the first network address. The recipient client is operable to receive from the server the uploaded file.

### BRIEF DESCRIPTION OF THE DRAWING

Preferred and alternative embodiments of the present invention are described in detail below with reference to the following drawings.

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a block diagram illustrating an information-gathering process according to an embodiment of the invention; and

FIG. 4 is an illustration of a process according to an embodiment of the invention.

### DETAILED DESCRIPTION OF THE PREFERRED EMBODIMENT

An embodiment of the invention includes computer software that allows desktop-to-desktop sharing of digital content including photos, video, and documents to a selected group of friends, family, or business associates.

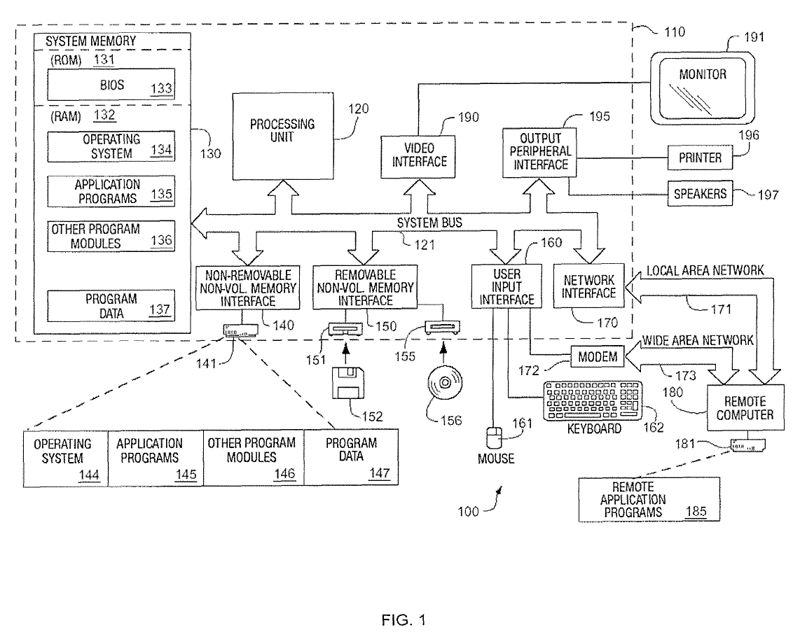

FIG. 1 illustrates an example of a suitable computing system environment 100 on which an embodiment of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

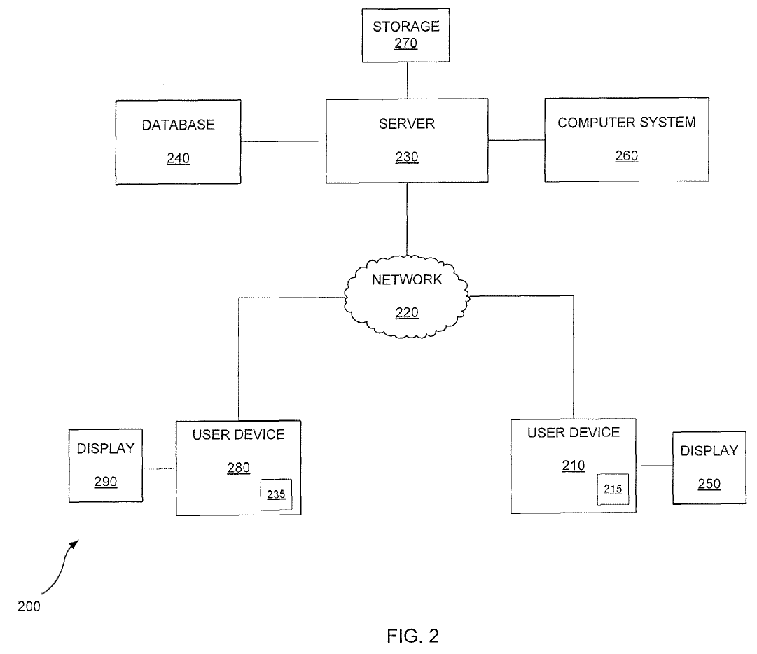

Referring now to FIG. 2, an embodiment of the present invention can be described in the context of an exemplary computer network system 200 as illustrated. System 200 includes electronic user devices 210, 280, such as personal computers, workstations or other processing devices (e.g., personal digital assistants), that are linked via a communication medium, such as a network 220 (e.g., the Internet), to an electronic device or system, such as a server 230. The server 230 may further be coupled, or otherwise have access, to a database 240, electronic storage 270 and a computer system 260. Although the embodiment illustrated in FIG. 2 includes one server 230 coupled to two user devices 210, 280 via the network 220, it should be recognized that embodiments of the invention may be implemented using two or more such user devices coupled to one or more such servers.

In an embodiment, each of the user devices 210, 280 and server 230 may include all or fewer than all of the features associated with the computer 110 illustrated in and discussed with reference to FIG. 1. User devices 210, 280 may include or may be otherwise coupled to a computer screen or display 250, 290, respectively. User devices 210, 280 can be used for various purposes including both network- and local-computing processes.

The user devices 210, 280 are linked via the network 220 to server 230 so that computer programs, such as, for example, client applications 215, 235, running respectively on the user devices 210, 280 can cooperate in two-way communication with server 230. One or more of the client applications 215, 235 can be transmitted to user devices 210, 280 over the network 220 from the server 230 or other device for subsequent installation on user devices 210, 280.

Server 230 may be coupled to database 240 and/or electronic storage 270 to retrieve information therefrom and to store information thereto. Additionally, the server 230 may be coupled to the computer system 260 in a manner allowing the server to delegate certain processing functions to the computer system.

An embodiment of the invention includes the capability to distribute digital files from one PC, such as user device 210, to another PC, such as user device 280, using, for example, a store-and-forward server model. Files may be selected at the user device 210 using client application 215 and uploaded to server 230 for temporary storage. When one or more recipients, such as user device 280, of the shared content are connected to the Internet or otherwise in communication with server 230, the files are immediately downloaded to, for example, the client application 235 on user device 280. Content may be stored on the server 230 only as long as it takes to be distributed to all of the recipients.

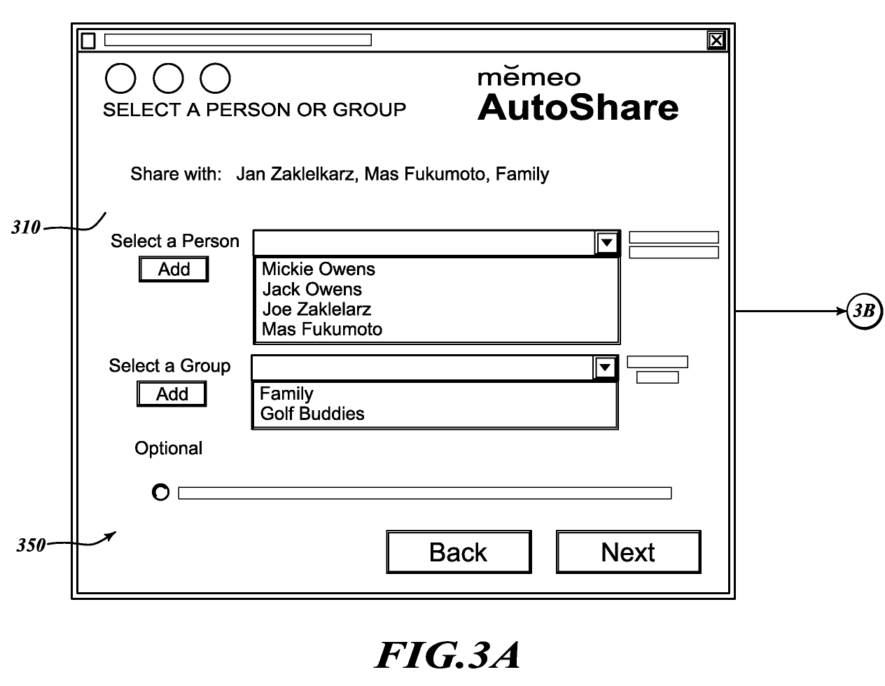

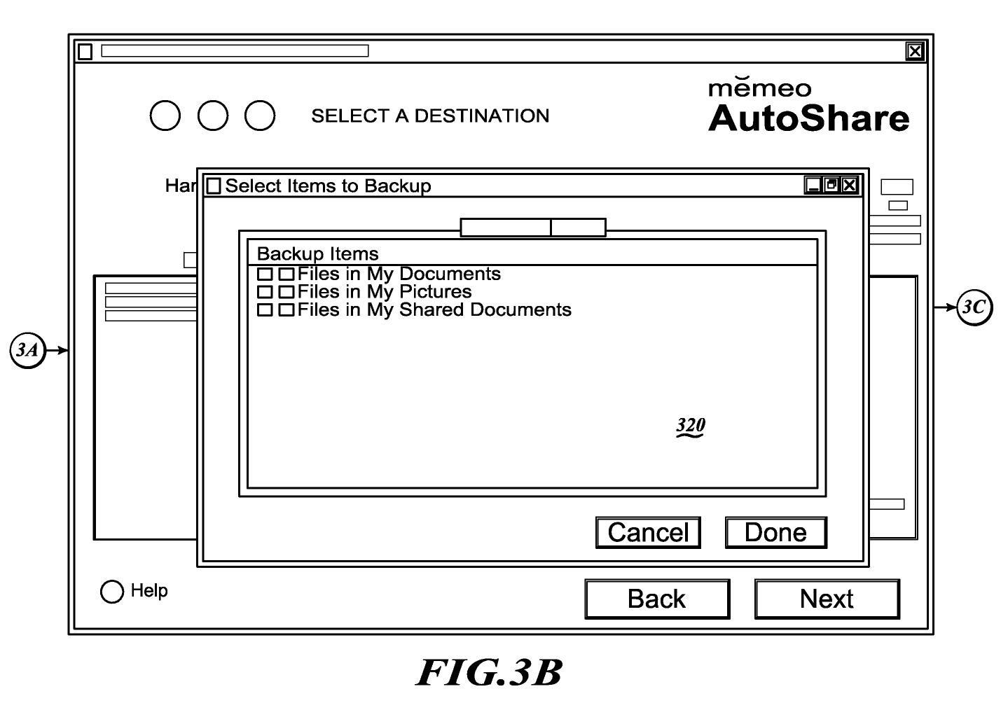

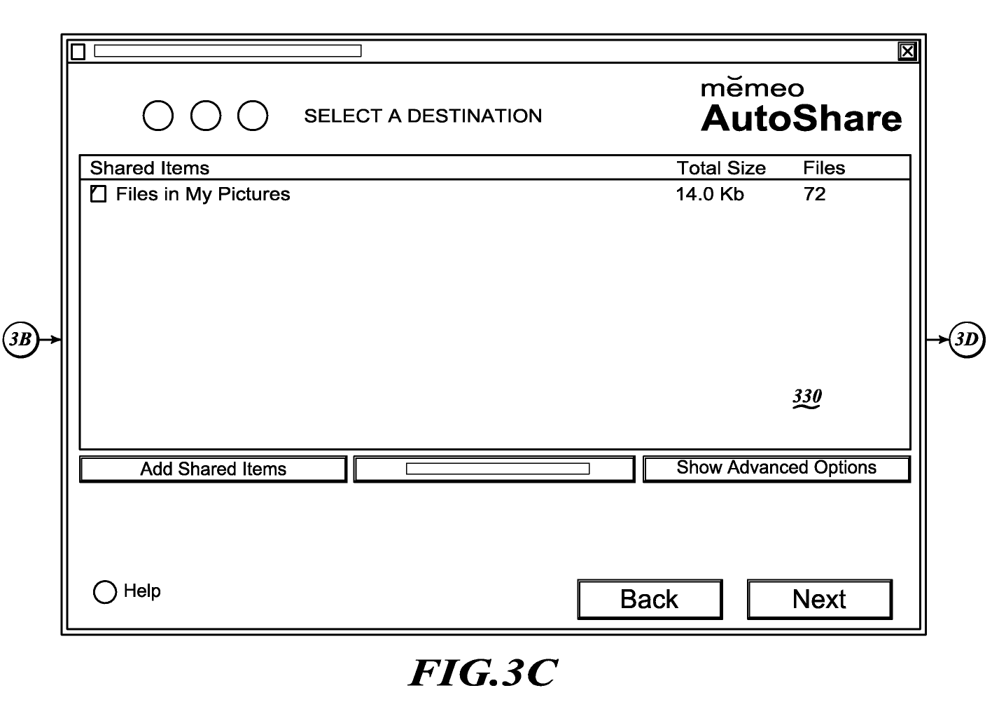

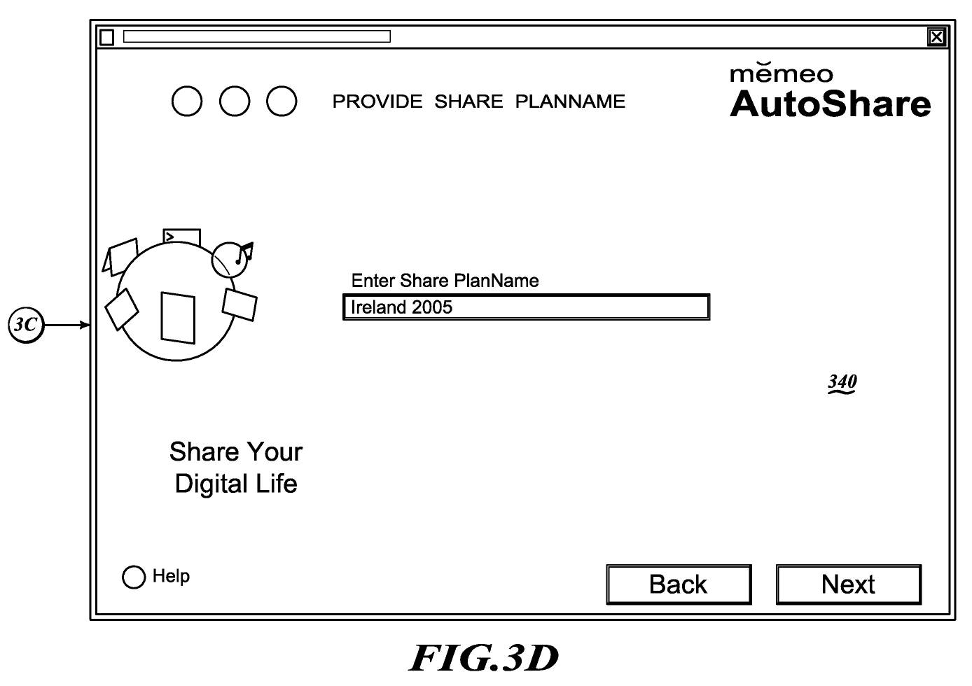

Referring now to FIG. 3, and in an embodiment, the sharing process starts with a user of user device 210 running the client application 215. The running client application 215 can provide one or more user-interface windows 310-340 that enable the user to create one or more sharing tasks as described more fully hereinafter. Using window 310, the user can select from a list of pre-stored names and/or groups of names, each of whom/which having associated email or other network addresses, a set of such names/groups with whom the user wants to share a set of files. Alternatively or additionally, the user can specify an email address or a set of email addresses corresponding to individuals with whom she/he wants to share a set of files.

After selecting the set of recipients, and using window 320, the user can select from among a list of folders, or create, a folder containing or to contain digital files that the user wishes to share with the recipient set. In the illustrated example as shown in window 330, the user has selected a pre-existing folder labeled “My Pictures.” Upon user selection of the “My Pictures” folder, the client application 215 can create and store as a share plan a unique association between the “My Pictures” folder and the recipient set selected using window 310. Using window 340, the user can provide a name to the share plan for future reference. Subsequently, whenever the user uploads (e.g., from a digital camera) or otherwise places one or more digital files in the “My Pictures” folder, the client application 215 will, without further action on the part of the user, automatically send such files, via the server 230, to the recipient set associated by the client application 215 with the “My Pictures” folder.

In an embodiment, the user can specify when an established share plan will expire. This allows the user to define a finite time period during which the recipient set will receive files from the user. Additionally, and as indicated by radio selection button 350, the user can specify that shared files be encrypted or otherwise secured. Such security can be established by, for example, a private/public key exchange.

In an embodiment, upon the client application 215 directing a set of files to the server 230 for sharing with the recipient list, the source client application 215 and/or server 230 may submit an emailed, for example, invitation to one or more recipients of the set to participate in the file-sharing arrangement created by the user of user device 210. Each recipient of the invitation can choose to accept, ignore or decline the file-sharing invitation. If the recipient chooses to accept, then the server 230 may provide, or request another device (not shown) to provide, a recipient client application 235 to the recipient's computer, such as user device 280. If the recipient is already a participant or otherwise has previously installed the client application 235, the “connection/subscription” to the shared files may be automatic. The shared files will be downloaded to user device 280 in the background. Moreover, the recipient can be notified when file content has been fully downloaded to user device 280 and is ready to use.

In an embodiment, upon the client application 215 directing a set of files to the server 230 for sharing with the recipient list, the server temporarily stores the file set in storage 270 for subsequent distribution to the set of recipients. If the user device 280, for example, used by a recipient is connected to the Internet or otherwise in network communication with the server 230, the client application 235 may poll the server 230 to determine if there are any new files that are available and submitted by client application 215. Alternatively, the server 230 may poll the user device 280 to determine if the user device 280 is available to download from the server 230 new files that are available and submitted by client application 215. If there are new files available, and the server 230 and user device 280 can communicate with one another, the new files stored on server 230 are immediately downloaded to the user device 280. Otherwise, the new files remain stored on the server 230 until such time as the user device 280 is available to download the new files. After the new files have been downloaded to the user device 280, the server may purge the new files from storage 270.

Once the new files are downloaded to the user device 280, the recipient may receive a notification that the recipient has downloaded the files. In an embodiment, the newly downloaded files are stored to a directory, specified by the recipient using client application 235, on the hard drive of user device 280. Moreover, at the instruction of the recipient, the client application 235 can automatically save any received shared images as a desktop image or as part of a screensaver application.

In an embodiment, a user of client application 215 and/or client application 235 may specify that files uploaded by user device 210 in a certain format be transformed to a different format prior to or upon receipt by a recipient. For example, the client application 215 and/or client application 235 may be instructed to convert any files in a PDF format into a JPG or GIF format prior to their uploading by client application 215 or upon receipt by client application 235.

Additionally, the server 230 may be configured to “trickle” large files to the client application 235 to minimize the recipient's file-transfer wait time.

In an embodiment, recipients can in turn share received content with other recipients, thus creating a “viral” effect. For example, a recipient using client application 235 could, in a manner similar to that described with reference to FIG. 3 using windows similar to windows 310-340, create a share plan whereby files received from client application 215 are automatically shared in turn with a recipient set of the choosing of the recipient using client application 235.

As alluded to above herein, optionally advantageous is the use of subscription feed model whereby the server 230 “pushes” content received from client application 215 to client application 235 without the need for client application 235 to poll the server 230.

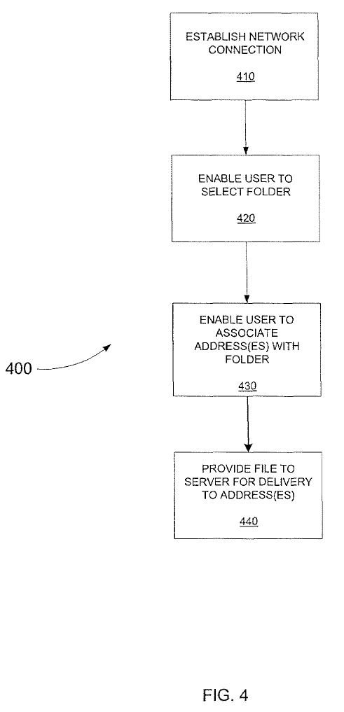

FIG. 4 illustrates a process 400 according to an embodiment of the invention. The process 400 is implementable in a first electronic device coupled to a server. The process 400 is illustrated as a set of operations shown as discrete blocks. The process 400 may be implemented in any suitable hardware, software, firmware, or combination thereof. The process 400 may be implemented in computer-readable instructions that can be sent from one computing or other electronic device to another over a network. The order in which the operations are described is not to be necessarily construed as a limitation.

At a block 410, a network connection is established between the first electronic device and the server. For example, a user of the user device 210 may instruct an application 215 executed by the user device 210 to initiate communication with the server 230.

At a block 420, a user of the first electronic device is enabled to select a first electronic folder residing on the first electronic device. For example, and referring to FIG. 3, using window 320, the user can select from among a list of folders, or create, a folder containing or to contain digital files that the user wishes to share with a recipient set. In the illustrated example as shown in window 330, the user has selected a pre-existing folder labeled “My Pictures.”

At a block 430, the user is enabled to associate a first network address with the first electronic folder. For example, using window 310, the user can select from a list of pre-stored names and/or groups of names, each of whom/which having associated email or other network addresses, a set of such names/groups with whom the user wants to share a set of files. Alternatively or additionally, the user can specify an email address or a set of email addresses corresponding to individuals with whom she/he wants to share a set of files. Upon user selection of the “My Pictures” folder, the client application 215 can create and store as a share plan a unique association between the “My Pictures” folder and the recipient set selected using window 310. Using window 340, the user can provide a name to the share plan for future reference.

At a block 440, in response to the user placing a file in the first electronic folder, the file is automatically provided to the server for delivery to a second electronic device associated with the first network address. For example, whenever the user uploads (e.g., from a digital camera) or otherwise places one or more digital files in the “My Pictures” folder, the client application 215 will, without further action on the part of the user, automatically send such files, via the server 230, to the recipient set associated by the client application 215 with the “My Pictures” folder.

While a preferred embodiment of the invention has been illustrated and described, as noted above, many changes can be made without departing from the spirit and scope of the invention. Instead, the invention should be determined entirely by reference to the claims that follow.

The embodiments of the invention in which an exclusive property or privilege is claimed are defined as follows:

1. A system, comprising:
a server;
a source client executable on a first electronic device configured to be in communication with the server, the source client operable to automatically upload a file to the server in response to a user of the first electronic device placing the file in a first electronic folder, the source client configured to associate a first network address with the first electronic folder in response to a user instruction; and
a recipient client executable on a second electronic device configured to be in communication with the server, the second electronic device being located at the first network address, the recipient client operable to receive from the server the uploaded file.

2. The system of claim 1 wherein:
the recipient client is configured to poll the server; and
the server downloads the file to the recipient client only after being polled by the recipient client.

3. The system of claim 1 wherein:
the server is configured to poll the recipient client; and
the server downloads the file to the recipient client only after determining that the second electronic device is in actual communication with the server.

4. The system of claim 1 wherein the server is configured to store the file in a memory until the recipient client receives the file.

5. The system of claim 4 wherein the server is configured to purge the file from the memory after downloading the file to the recipient client.

6. The system of claim 1 wherein the file is encrypted.

7. The system of claim 6 wherein the file is encrypted by the source client.

8. A method implementable in a first electronic device coupled to a server, the method comprising:
establishing a network connection between the first electronic device and the server;
enabling a user of the first electronic device to select a first electronic folder residing on the first electronic device;
enabling the user to associate a first network address with the first electronic folder; and
in response to the user placing a file in the first electronic folder, automatically providing the file to the server for delivery to a second electronic device associated with the first network address.

9. The method of claim 8 wherein the server downloads the file to the first network address only after being polled by the second electronic device.

10. The method of claim 8 wherein the server downloads the file to the first network address only after determining that the second electronic device is in actual communication with the server.

11. The method of claim 8 wherein the server is configured to store the file in a memory until the first network address receives the file.

12. The method of claim 11 wherein the server is configured to purge the file from the memory after downloading the file to the first network address.

13. The method of claim 8, further comprising enabling the user to encrypt the file.

14. A method of transferring a computer program product from at least one first computer to at least one second computer connected to the at least one first computer through a communication medium, the method comprising the steps of:
(a) accessing, on the at least one first computer, computer-executable instructions that, when executed on a data processing system, enable the processing system to perform at least the steps of:
(1) establishing a network connection between a first electronic device and a server,
(2) enabling a user of the first electronic device to select a first electronic folder residing on the first electronic device,
(3) enabling the user to associate a first network address with the first electronic folder, and
(4) in response to the user placing a file in the first electronic folder, automatically providing the file to the server for delivery to a second electronic device associated with the first network address; and
(b) transferring the computer-executable instructions from the at least one first computer to the at least one second computer through the communications medium.

15. The method of claim 14 wherein the server downloads the file to the first network address only after being polled by the second electronic device.

16. The method of claim 14 wherein the server downloads the file to the first network address only after determining that the second electronic device is in actual communication with the server.

17. The method of claim 14 wherein the server is configured to store the file in a memory until the first network address receives the file.

18. The method of claim 17 wherein the server is configured to purge the file from the memory after downloading the file to the first network address.

19. The method of claim 14, wherein the instructions further enable the processing system to enable the user to encrypt the file.
